(19) United States
(12) Patent Application Publication
(10) Pub. No.: US 2005/0249840 A1
(43) Pub. Date: Nov. 10, 2005

(54) Active yeast in dry granular or powder form obtained through treatment of a mixture of known yeasts and its use in a pre-packed long-life preparation to be completed with the addition of water

(75) Inventor: Giorgio Vaiani, Ceparana di Bolano (IT)

Correspondence Address: RICHARD M. GOLDBERG, 25 EAST SALEM STREET, SUITE 419, HACKENSACK, NJ, 07601, US

(73) Assignee: B.F.L. Bakery Future Lines S.r.I., Ceparana (IT)

(21) Appl. No.: 11/118,937

(22) Filed: Apr. 28, 2005

(30) Foreign Application Priority Data
May 6, 2004 (IT) GE2004A000037
May 20, 2004 (IT) GE2004A000044

(51) Int. Cl. A23L 1/28

(52) U.S. Cl. 426/62

(57) ABSTRACT

Active yeast in granular or powder form for the production of bread, cakes, and other bakery products, includes active yeast obtained by treatment of a mixture of 35-40% by weight of natural yeast in an active powder and 55-60% by weight of compressed yeast, in order to attain a final product composed indicatively of 70% of active yeast and 30% of compressed yeast and with a neutral pH.

The present invention refers to a procedure for the preparation of a new active yeast in dry granular or powder form, easy to transport and preserve over time.

As is well known, for the leavening of bread and cakes natural yeasts by acid fermentation or compressed yeasts (such as brewer's yeast) by alkaline fermentation may be used.

One of the greatest difficulties of working with a natural yeast is that of knowing the “right amount” of leavening, in that the fermentation is closely linked to the environmental conditions.

Upstream of this problem there is an even greater one, consisting of the “preparation” of the natural yeast where by preparation one means all the operations necessary to keep the natural yeast active and to bring it to be ready for use as such in dough or pastry.

The processing times are to be pointed out in this preparatory phase, which are very long and that require particular care, attention and skill (therefore the need for specialised personnel), without which hours and hours of work may be compromised.

Another very important factor of this phase is to be attributed to the environmental conditions in which the person who is preparing a natural yeast has to operate.

All together these problems have encouraged the spreading of the production of bread and cakes with compressed yeasts that produce leavening in part comparable to that obtained using natural yeast, however in much shorter times and with a much simpler handling of the process.

The difference between the two leavening systems can be found in the finished product with the following most evident characteristics:

Bread and cakes obtained with natural yeast—

Keep for much longer, a consequence of a higher acidity of the pastry or dough with slower development of mould, have a “natural” aroma and taste, have a very regular texture as a consequence of a slow and gradual leavening, are considerably easier to digest as a consequence of an enzymatic “pre-digestion” that occurs during the leavening.

Bread and cakes obtained with compressed yeast—

Keep for a much shorter time due to the higher alkalinity of the pastry or dough and for the ease of formation of mould, have a particular smell and taste, have an irregular texture, are much less easy to digest.

On the basis of that said earlier, natural yeast may only be used currently by large bread and cake companies, who can afford the specialised personnel for the treatment and preparation of natural yeast starting from the mother yeast. Small scale producers use compressed yeast (such as brewer's yeast) even though they obtain a less rich product that does not keep so long.

To obviate the inconveniences of the preparation of natural yeast as described, a procedure has been used, according to the Italian patent no. 1.136.191 of 24.07.80, by means of which a natural yeast may be put on the market that is easy to transport and preserve, even for a period of two months.

According to this patent, the mother yeast is transformed with a process that is carried out in a specialised factory, in such way as to give the user who normally uses compressed yeast, a product to use more easily and with considerable savings of time and costs.

The current state of the technique arranged thus, with this invention one tends to bring certain improvements to the field of yeasts, in such way as to increase the life cycle of the yeast in its normal conditions; allow the preservation, transportation and storage of the yeast at room temperature; reduce the quantity of yeast useful for bread making compared to that required by the normal and well known use of natural yeasts; reduce the re-hydration time in the kneading phase; increase the weight of use of the yeast transforming it into bread; improve the taste, aroma and the freshness of the bakery product through the new yeast; allow temperature changes even below 0 DEG C. without harm.

The new yeast according to the present invention is obtained through opportune treatment of a mixture of known yeasts i.e. a mixture substantially between compressed yeast and natural yeast. According to a first solution of the present invention an active yeast in granular or powder form for the production of bread and cakes etc., is obtained by means of treatment of a mixture of compressed yeast and natural yeast in active powder.

As already explained natural yeast and the relative separation liquid, are well known and for instance are produced by means of the method subject of the aforesaid Italian Patent No. 1.136.191.

The third element mentioned above is the compressed yeast or brewer's yeast that is normally used by small and medium sized bakers as explained above.

According to present invention, with reference to said composition, the mentioned components i.e. the natural yeast, the separation liquid of the natural yeasts and the compressed yeast, are opportunely mixed and treated as indicated in the following:

FIRST PHASE—One takes the natural yeast in active powder and mixes it with the liquid derived from the preparation of the same natural yeast, obtained during the process of drying for separation through condensation, then adding the compressed yeast. One mixes them together for about five minutes at low speed, avoiding overheating.

SECOND PHASE—By means of a conveyor belt or other suitable means, the mixture is sent to a multiple-cylinder machine (at least three cylinders) with differentiated openings, in such way that the product starts the process of integration with the ingredients used. The last cylinder has the task of sending out the mixture in the form of homogeneous and cold pastry or dough, as if it were an accurately homogeneous, silk ribbon, thereby ensuring the integration of the three products.

THIRD PHASE—The homogenised mixture obtained in the previous phase, is placed in a suitable hopper and passes, in a gradual way, to a mechanical granulator with openings of about 4 mm. Thus one obtains a granular product such that it may be passed to a drying machine on a fluid bed with an entry temperature of about 65 DEG and, after contact with the product, with an exit temperature of about 35-37 DEG C. In a time of about 12-15 minutes, the product is ready with a humidity of between 7 and 9%.

FOURTH PHASE—In this phase, the dried granulate obtained in the previous phase, passes to another mechanical granulator with openings of 2 mm.

FIFTH PHASE—As a final phase, the granulate is cooled to a temperature of about 20 DEG C. and then is packed and stored at a temperature of about 20 DEG C.

The active yeast obtained under a granular form according to present invention, may therefore be conveniently used by bakers, pastry chefs, etc., even small scale, in that the new yeast has the advantages as listed in the following: the life cycle of the new yeast increases up to 3-4 months from the date of packaging, it allows preservation, transport and storage of the yeast without the use of the cold chain, with a maximum temperature equal to 20 DEG C., it requires smaller quantities of yeast compared to those required in normal utilisations, it reduces the time of re-hydration, during processing the weight of the new yeast increases by 32-34% compared to the initial weight, transforming itself into bread, the taste, aroma and freshness of the baked product all improve with the new yeast, in that the final product has 70% natural yeast in active powder, it allows temperature changes even below 0 DEG C. without harm, bearing in mind that such low temperatures provoke damage to the known natural yeast. As an example for orientation, the quantities of the various ingredients are as indicated in the following: natural yeast in active powder 35-40% in weight, separation liquid 1-2% in weight, compressed yeast 55-58% in weight, with attainment of a final product composed indicatively of 70% of active yeast and 30% of compressed yeast and with a neutral pH.

Naturally the quantities indicated may be varied on the basis of particular needs, just as other products that may improve in certain cases the composition of the yeast and the result of the baking may be added to the ingredients of the composition according to the invention:

A second solution according to this invention is simply based on the blending of the two main ingredients and in detail of: natural yeast in active powder, 40-45% in weight, baker's yeast or compressed yeast, 55-60% in weight. With reference to said composition, the above mentioned components are opportunely mixed and treated as indicated in the following.

FIRST PHASE—One takes the natural yeast in active powder and one hydrates it bringing the level of humidity from approximately 6% to about 10%. One adds the compressed yeast generally in powder form with a temperature of about 7 DEG C.

SECOND PHASE—the mixture is sent to a multiple-cylinder machine with differentiated openings, in such way that a process of amalgamation of ingredients takes place, with attainment of a homogenised paste.

THIRD PHASE—The homogenised paste is sent to a granulator and dried in a fluid bed machine, in such way as to obtain a product with 7-9% of humidity.

FOURTH PHASE—The dry and cooled granulate may be packaged either in granular form or ground to a powder.

The active yeast according to the present invention allows a great advantages, i.e. the pre-packed, long-life preparation including floor, yeast and salt to be completed with just the addition of water.

Nowadays various types of yeasts are known that are used in the bakery industry etc. These yeasts are in practice: natural yeast in paste with acid fermentation, dry natural yeast with acid fermentation, compressed yeast (brewer's yeast) in pats with basic fermentation, dehydrated compressed yeast (brewer's yeast) with basic fermentation.

None of these known yeasts may be used to carry out the pre-packing of long-life containers or bags equipped with all the components necessary in the loose state (flour, yeast, salt, etc.) to which it is only necessary to add water so as to obtain the dough or pastry to cook.

Indeed it is not possible to arrange these packets with natural yeast which being a paste creates immediate fermentation inside the mass with deterioration of the packed contents.

Neither is it possible to use natural yeast in powder in that one would immediately create a leavening due to the humidity of the flour that is 15% on average.

Even the use of compressed yeast in pats does not allow pre-packing of the composition making up the bread-baking, in that such yeast is made up of living cells within a substratum containing a minimum humidity of 75%. This high humidity immediately activates fermentation.

Even compact dehydrated yeast in powder cannot be used to prepare the packet ready for use with just the addition of water, in that it is extremely hygroscopic and absorbs humidity from the environment. In general this brewer's yeast in powder form may only be used if vacuum packed or in a modified atmosphere.

Therefore all the said yeasts if mixed and kept for long periods in close contact with flour, will create processes of cell duplication and consequent fermentation, making the packaging in packets or containers impossible given that the mixture would undergo damage with superficial growth of mould.

Products destined to domestic use exist i.e. packets containing flour, salt and yeast, but such yeast is placed in a small packet with no contact with the flour (see the dehydrated compressed yeast as mentioned above) or it is in the form of raising agent based on sodium pyrophosphate and bicarbonate of soda. This latter example is not suitable for bread-making. The active yeast according to the invention presents: an excellent preliminary blending with the flour and salt in dosed quantities and this allows it to be preserved, transported and stored without the use of the cold chain, with a maximum temperature of up to 20 DEG C. has a life cycle of up to 3-4 months from the date of packaging, does not suffer from the humidity present in the flour in that it is in the dry state and with neutral pH practically.

Since this new yeast may be used normally and indifferently by large or small bakers or pastry chefs, the preparation according to the invention that envisages the set of all the components necessary with the exclusion of water, may be bought in containers of various shapes and sizes and used by anyone, large, medium or small, or even by housewives. Clearly other possible products or ingredients may be added to the pre-packed mixture as described that are compatible with the basic ingredients i.e. flour, yeast and salt.

1. Active yeast in one of granular and powder form for the production of bread, cakes, and other bakery products comprising active yeast obtained by treatment of a mixture of a compressed yeast and a natural yeast in an active powder.

2. Active yeast according to claim 1, wherein ingredients forming said mixture include:
35-40% by weight of natural yeast in an active powder,
55-60% by weight of compressed yeast,
whereby to attain a final product composed indicatively of 70% of active yeast and 30% of compressed yeast and with a neutral pH.

3. Active yeast according to claim 2, further comprising a separation liquid of 1-2% by weight, added to the mixture.

4. Active yeast according to claim 1, wherein the ponderal composition of the mixture to treat varies as a function of desired leavening action in production of the bread, cakes and other bakery products.

5. Active yeast according to claim 1, further comprising obtaining the active yeast by:
hydrating the natural yeast in the active powder to bring the level of humidity thereof from approximately 6% to about 10%;
adding the compressed yeast in power form with a temperature of about 7° C. to form the mixture;
passing the mixture through differentiated openings of a multiple-cylinder machine, in such a way that a process of amalgamation of ingredients takes place, with attainment of a homogenized paste;
sending the homogenized paste to a granulator;
drying the granulated homogenized paste in a fluid bed machine, in such a way as to obtain a granulate product with 7-9% of humidity;
cooling the granulate product; and
packing the dry and cooled granulate product in one of:
granular form and
ground to a powder.

6. Active yeast in one of granular and powder form for the production of bread, cakes, and other bakery products comprising active yeast obtained by treatment of a mixture of natural yeast in an active powder and one of baker's yeast and dry compressed yeast, whereby a resultant formed new active yeast is adapted to be used by bakers and pastry chefs in a smaller size, compared to known natural yeasts with acid fermentation and compressed yeast with alkaline fermentation.

7. Pre-packed preparation with flour, yeast and salt to be completed with the addition of water according to claim 3.

8. A method of forming an active yeast in one of granular and powder form for the production of bread, cakes, and other bakery products, comprising the step of mixing a compressed yeast and a natural yeast in an active powder.

9. A method according to claim 8, wherein said step of mixing includes the step of mixing 35-40% by weight of natural yeast in an active powder and 55-60% by weight of compressed yeast, whereby to attain a final product composed indicatively of 70% of active yeast and 30% of compressed yeast and with a neutral pH.

10. A method according to claim 9, further comprising the step of adding a separation liquid of 1-2% by weight, to the mixture.

11. A method according to claim 8, further comprising the step of varying the ponderal composition of the mixture to treat as a function of desired leavening action in production of the bread, cakes and other bakery products.

12. A method according to claim 8, further comprising the steps of:
hydrating the natural yeast in the active powder to bring the level of humidity thereof from approximately 6% to about 10%;
adding the compressed yeast in power form with a temperature of about 7° C. to form the mixture;
passing the mixture through differentiated openings of a multiple-cylinder machine, in such a way that a process of amalgamation of ingredients takes place, with attainment of a homogenized paste;
sending the homogenized paste to a granulator;
drying the granulated homogenized paste in a fluid bed machine, in such a way as to obtain a granulate product with 7-9% of humidity;
cooling the granulate product; and
packing the dry and cooled granulate product in one of:
granular form and
ground to a powder.

13. A method of forming an active yeast in one of granular and powder form for the production of bread, cakes, and other bakery products, comprising the step of mixing a natural yeast in an active powder and one of baker's yeast and dry compressed yeast, whereby a resultant formed new active yeast is adapted to be used by bakers and pastry chefs in a smaller size, compared to known natural yeasts with acid fermentation and compressed yeast with alkaline fermentation.

14. A method according to claim 10, further comprising the step of forming a pre-packed preparation with flour, yeast and salt to be completed with the addition of water according to claim 3.
